(19) United States
(12) Patent Application Publication
(10) Pub. No.: US 2004/0215531 A1
(43) Pub. Date: Oct. 28, 2004

(54) Computer generated merchandise return labels with rules-based coding

(76) Inventors: Edward J. Stashluk JR., Austin, TX (US); Michael J. Stevens, Austin, TX (US); Jennifer A. Milch, Austin, TX (US); Phillip J. Sidari, Austin, TX (US); Terry Combs, Cedar Park, TX (US)

Correspondence Address: BAKER BOTTS L.L.P., PATENT DEPARTMENT, 98 SAN JACINTO BLVD., SUITE 1500, AUSTIN, TX, 78701-4039, US

(21) Appl. No.: 10/775,368

(22) Filed: Feb. 10, 2004

Related U.S. Application Data
(60) Provisional application No. 60/446,142, filed on Feb. 10, 2003.

(51) Int. Cl. G06F 17/60

(52) U.S. Cl. 705/28

(57) ABSTRACT

A method that facilitates customer returns of merchandise by generating return labels that integrate a carrier-compliant format and return processing data on the same label. A return label generating process accesses data about an item to be returned, the customer, the package in which it is expected to be shipped, and the transaction associated with the item. The process evaluates this data in view of stored merchant rules, to determine how the package will be shipped. It then generates a label whose coding and format ensure that the package will be handled in this manner.

### RELATED PATENT APPLICATION

This application claims the benefit of U.S. Provisional Application Serial No. 60/446,142 filed Feb. 10, 2003 and entitled “Retail Package Returns Service System Using Postage Due Labels”.

### TECHNICAL FIELD OF THE INVENTION

This invention relates to merchandise return methods and systems, and more particularly to a method of managing returns of goods purchased from retailers and other merchants.

### BACKGROUND OF THE INVENTION

The typical returns process for most direct retailers, includes providing a static return label on the order summary where the customer pays out-of-pocket and finds a shipper to start the return process. Customers who uses this type of return system have been shown to have lower satisfaction with the returns process than other key customer service areas. The process suffers from lack of visibility because the merchant does not receive advance notification of in-transit returns. As a result, customer service and warehouse receiving does not have visibility into the flow of returns track packages or deliver early customer notifications. The process further suffers from inefficient transportation load-balancing. Shipments are not load-balanced by warehouse by the carrier, forcing additional intra-warehouse transportation and processing.

The growing use of electronic commerce as a customer marketplace has led to a greater need for appropriate customer return methods. In the absence of conveniently located retail stores, the customer needs an acceptable method of returning goods. Various “reverse logistics” systems have been developed to meet this need. These systems are a subset of the growing industry of “supply chain management” systems, and are designed to help merchants manage customer returns.

For returns, as opposed to forward deliveries, the typical returns process requires the customer to take the package to the carrier and pay shipping costs. As an alternative to customer-paid shipping, some merchants have turned to a merchandise return service available from the United States Postal Service (USPS), which permits the customer use an addressed and prepaid merchandise return label. The customer may deposit the package at any post office or in a mailbox, and postage is paid by the merchant. The merchant decides the ultimate return shipping cost to the customer, such as by deducting that cost from the customer's credit.

Existing merchandise return service methods, such as that offered by the USPS, although convenient for the customer, can be costly and time consuming for the merchant.

It is not enough to provide customers exceptional service in getting packages out the door and into the home. Today, retailers must provide an exceptional returns service. The reward is loyal, better and more profitable customers. The risk of a poor returns experience is alienating an entire generation of direct shoppers who then lose confidence in the brand itself and in the direct purchasing process in general.

For most retailers, returns management is an afterthought. Instead of proactively addressing return-related issues starting with the original order, many retailers wait until the return package has arrived in the warehouse. This creates uncertainty on the part of the customer and inefficient operations inside the warehouse. The average retailer provides a basic level of information about how to return a product on the outbound order summary. In most cases this includes a set of return instructions and an address to which the return package must be mailed. The customer must package the return and find a convenient location to purchase return postage (US Post Office or another shipper). Once the return package is received by the retailer (typically 5 -10 days later), it normally takes an additional 3-4 days for the return to be processed. During this time, the customer has little, if any, insight into what is happening with her return. To insure that the credit has been processed, the customer must wait 2-3 billing cycles to see it appear on her credit card statement or she must contact the retailer's customer service department. Typically, retailers do little to leverage or exploit return reason codes, and seldom do they integrate marketing or loyalty programs within the returns process.

### BRIEF DESCRIPTION OF THE DRAWINGS

FIG. 1 illustrates a merchandise return process using postage due return labels in accordance with the invention.

FIG. 2 illustrates a return label in accordance with the invention.

FIG. 3 illustrates an example of bar code fields for the bar code of FIG. 2.

FIG. 4 illustrates a method of generating a return label in accordance with the invention.

FIG. 5 illustrates the use of the return label by the customer.

FIG. 6 illustrates the use of the return label at the return center for issuing customer credit.

FIG. 7 illustrates a process of generating return labels, using merchant rules.

### DETAILED DESCRIPTION OF THE INVENTION

This invention described herein is a merchandising method and system that permits a merchant to provide pre-authorized returns, for which the customer need not pay shipping charges. The merchant provides a special return label to the customer, which has machine readable data that enables shipping charges to be assessed at a point of delivery. The return label is generated according to stored merchant rules, which are evaluated against data associated with the returned item, such as data about the item itself, the transaction associated with the item, the customer, or the package in which the item is to be shipped. The return label is then generated and formatted to reflect shipping parameters that best satisfy the business rules.

For example, data on the return label may further ensure that the package is delivered to an initial point of return close to the customer, thereby providing “reverse zone skipping”. The return label may further have data that permits the merchant to dynamically route returned packages and that permits both the merchant and the customer to be quickly notified of the status of the return.

Once the label is printed, the package may be directly shipped to its final destination, or it may be routed to a returns center for further processing. If shipped to a returns center, the label is scanned, or otherwise electronically read, and compared to stored data that includes various “rules” associated with each merchant. A processing system is used to link each return package to its associated rules, and to provide various value added services, such as notice to the merchant and/or the customer and dispositioning of the item.

U.S. Patent Ser. No. 10/659,465, entitled “Method and System Using Return Labels with Dynamically Generated Multiple Datapoint Coding”, assigned to Newgistics, Inc., and incorporated herein by reference, describes such a return label, and the various delivery methods, label generation, coding, use, and other aspects of the return label. The present invention is directed to additional features of the label, such as its generation, format, and use.

The method is used by, or on behalf of, a “merchant”, which is typically a retail merchant. However, the concepts discussed herein may be applied to any merchant, including service providers who sell goods incidentally to the providing of services. The “return” may be for purposes of receiving credit for an item recently purchased, but may also be subsequent to events such as warranty claims, recalls, or for repairs.

The method described herein may be used in connection with a “reverse logistics return service”. This type of service is becoming increasingly popular, and permits merchants to “outsource” their returns process. For purposes of this description, these service providers are referred to as “returns providers”. They typically provide returns services for a number of different merchants, with part of their services being disposing of packages in accordance with the particular disposition rules of each merchant.

If the merchant uses such a returns provider, the returns label will further have data useful for identifying each merchant and may contain other data particular to that merchant. However, the methods described herein are also useful for returns systems that handle only returns for a single merchant, such as for a merchant having an in-house returns provider.

One example of a returns service that could incorporate use of the return label described herein is the SmartLabel™ service offered by Newgistics, Inc. This service makes use of a bar-coded shipping label, typically attached to an invoice received by the customer when the product is delivered to the customer. To return the product, the customer simply affixes the label to the return package, and drops the package anywhere into the U.S. Postal System (USPS), such as by dropping it into a mailbox. The label directs the package to a returns center maintained by the service provider. The returns provider assesses shipping charges, pays the carrier, and passes the shipping costs on to the merchant, who may then deduct those costs from the customer's credit for the returned item. The various services that the returns provider provides to the merchant include the return label, aggregation of packages to each merchant, transportation and processing services, payment of shipping charges, reporting, and notifications to the merchant and/or the customer.

For purposes of example herein, it is assumed that the carrier that ships the returned items is the United States Postal Service. However, the same concepts could be applied to a returns process that uses other carriers or multiple carriers, so long as each carrier has the equivalent of postage due capability, that is, the ability to collect shipping charges after the package is delivered, that is, from the returns provider (the package recipient) rather than from the customer.

### Overview of Returns with Postage Due Shipping

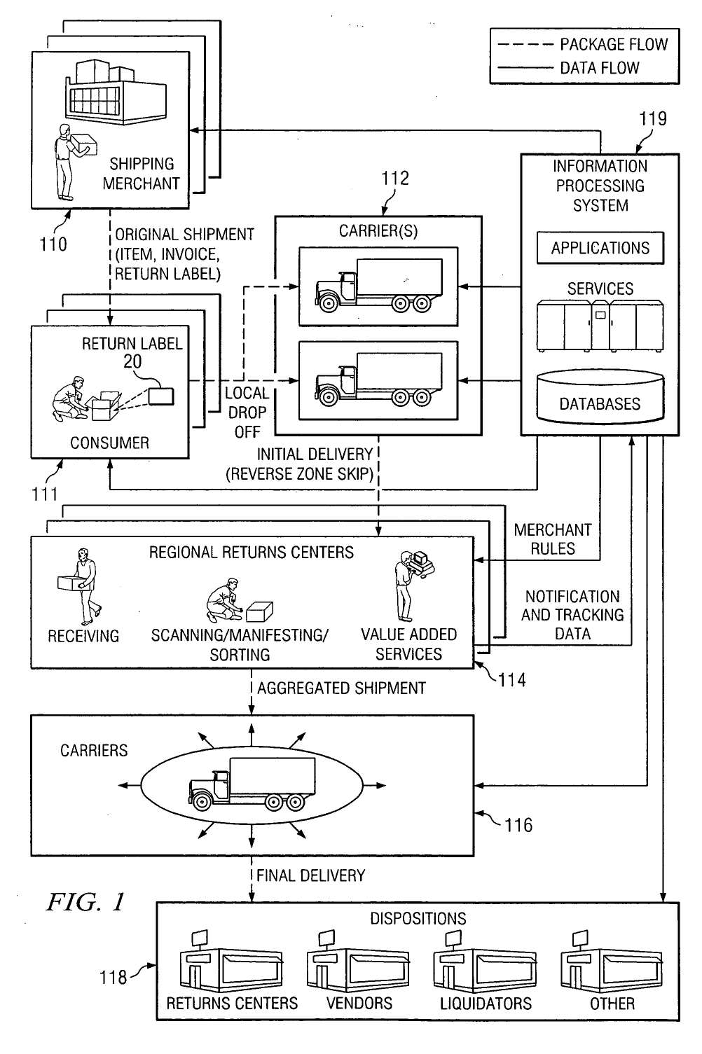

FIG. 1 illustrates a returns process that uses postage due return labels in accordance with the invention. In the embodiment of FIG. 1, returns are processed through a returns provider that handles returns for multiple merchants. However, as stated above, the method described herein may be easily adapted for a returns provider that handles only returns for a single merchant. In either case, the merchant is considered to “maintain” at least one returns center, whether by directly maintaining the returns center(s) or by associating with a third party that does so.

In Step 110, a merchant has delivered an item to a customer. In Step 111, the customer has decided to return the item, herein referred to as “the return item”.

A returns label 20 has already been, or is to be, provided to the customer. In the example of FIG. 1, the return label 20 is delivered as an enclosure with the customer's original order, such as by being part of the customer invoice or a separate insert.

In other embodiments, return label 20 could be downloaded from a data network and printed by the customer, or otherwise delivered to the customer by means other than being included with the merchandise delivery. For example, the return label 20 could be separately mailed or send as by facsimile. As another example, the customer might access a website provided by the merchant, link to a returns page, and download the data for printing the return label.

Return label 20 is “pre-authorized” in the sense that the customer need not seek authorization from the merchant. The customer is apprised by the merchant that returns are pre-authorized, such as by information on the invoice or other shipping documents. The notification may be explicit on the return label or elsewhere or may be implicit. The customer is further apprised that the customer need not pay shipping charges, such as by a “no postage necessary” printing on the return label 20.

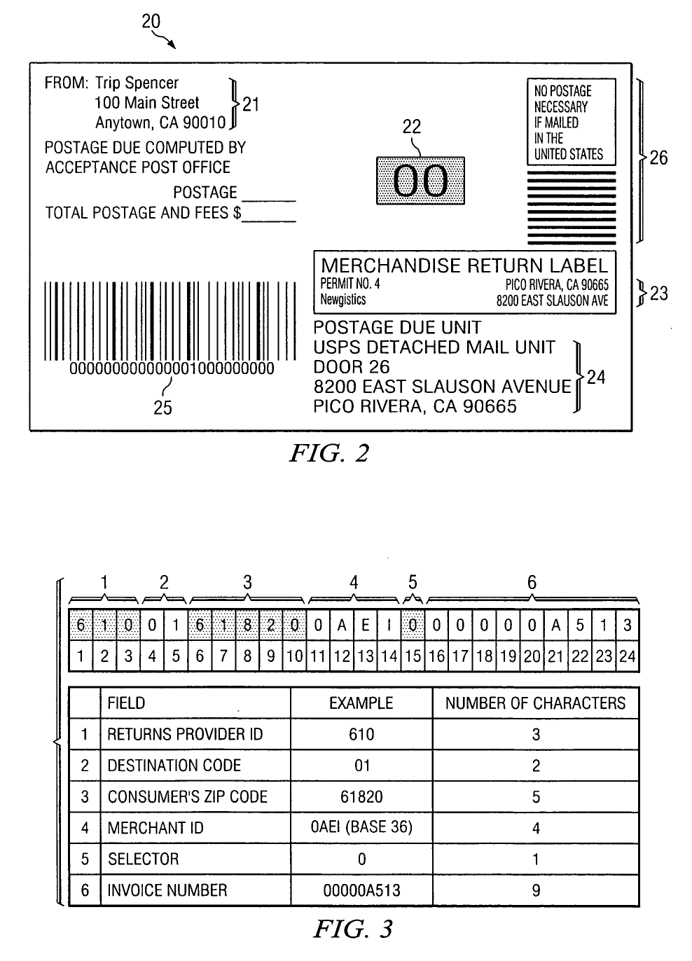

An example of a suitable return label 20 is described below in connection with FIGS. 2 and 3.

The customer affixes the returns label 20 to the packaging for the return item, and hands over the return item to a carrier, without paying any shipping charges to the carrier. The customer need not affix any indicia of postage or other shipping costs to the packaging. In the example of this description, the customer may simply deposit the package into the US postal system, by putting it into a mailbox (if postal compliant), dropping it off at a postal drop, or taking it to a post office. The return is local to the customer in the sense that the customer may select whatever drop-off point is most convenient.

As further explained below in connection with FIG. 2, return label 20 is preprinted to indicate at least the destination for the item and the package origin (the point where the customer places the package with a carrier). Typically, the destination and origin are identified by addresses, including postal codes. For purposes of this description, “postal codes” include the ZIP (zone improvement plan) codes of the USPS and similar codes used in other countries.

The returns label further indicates that delivery charges are to be paid by a recipient. It further identifies the transaction leading to the return. Typically, this is a purchase transaction and the identification is by invoice number or other indicia of the package or its contents. In other embodiments, the transaction could be a warranty claim or repair request.

In Step 112, the carrier delivers the return item to the returns provider. As stated above, in the embodiment of FIG. 1, the initial point of return for the package is a specialized returns center, which may receive returns for more than one merchant. The returns center may be regional for a large area such as the United States. In other words, a large geographic area may have a number of returns centers.

For a returns provider having regional returns centers, the return label 20 may ensure “reverse zone skipping”. At the time the data for each returns label 20 is composed, the destination address on the label 20 is determined.

The destination address is typically that of a carrier station (such as a postal center) nearest the customer. This may mean that return packages are carried from the customer drop-off location to a destination associated with the carrier for pickup by the returns provider. For example, where the carrier is the USPS, the package could be delivered to one of 21 regional bulk mail centers (BMCs). The package is delivered to the BMC closest to the location of the returns provider. The returns provider may then pick up accumulated packages addressed to it. Equivalently, the carrier then may deliver the package directly to the returns center. In either case, the destination address is considered to be “to” a returns center closest to the customer.

In Step 114, the returns provider receives the package from the carrier. The returns provider scans the return label on the package and weighs the package. Any special shipping flags or indicia are entered at this time. In this manner, the returns provider receives multiple packages, which may be items originating from multiple merchants, throughout a daily course of business.

In a process known as “manifesting”, the returns provider calculates the shipping charges due to the carrier and electronically manifests the carrier. Typically, this is done on a daily basis. In the example of this description, the returns provider pays the carrier, and is compensated by the merchant for carrier costs and other services.

The returns provider then sorts the packages by merchant, again using data printed on return label 20, and collects the packages associated with each merchant. The final destination code is encoded on the return label, and may also be printed in human readable form. For large volume merchants, the destination code may be associated with a package chute and/or a docking door.

The returns provider may also provide “value added” services for the benefit of the merchant, such as notification of the return to merchant or notification to the customer of receipt of the package. For example, the returns provider may use the scanned return label information to notify the customer and/or the merchant that the package has been received.

In Step 116, after aggregating the packages for each merchant, the returns provider further ships them in accordance with whatever policies are specified for that merchant. For example, the returns provider may palletize shipments back to the merchant. The return label data is used to create a bill of lading, with data such as pallet counts, package counts, and shipment weight.

In Step 118, the package is handled according to the disposition policy of the merchant, such as by being returned to stock, sent to a re-seller, liquidator, or otherwise disposed.

A processing center 119 is used to collect data scanned from return labels, and to process the returns. The processing center 119 includes computer processing equipment, including computers, data storage, and networking equipment, appropriate for communication of data to and from returns centers, merchants, and customer, as appropriate.

The computing equipment is programmed to fulfill the various data processing services described herein. For example, processing center 119 may provide a web page or other network-accessible data source, accessible by customers for obtaining information about returns and data for printing return labels. It also stores business rules from merchants, which are typically delivered to it by electronic transmission over a data communications network. As explained below, the processing center 119 match data on the return label to these merchant rules, which may specify disposition of the package or other rules for handling the return.

### Returns Label Provided to the Customer

FIG. 2 illustrates an example of a return label 20, suitable for use with the merchandise return method of FIG. 1. In the example of FIG. 2, the carrier is the USPS. Return label 20 incorporates data appropriate for the merchandise return service offered by the USPS, as well as data used for additional services provided by the returns provider. As stated above, other or additional carriers having the equivalent of postage due capabilities could be used, in which case, return label 20 would be modified to comply with the requirements of those carriers.

The customer's address 21 is printed on the upper left corner of label 20. This address matches the original delivery address.

The visual flag 22 is a human readable code, that can be used for various purposes. In the example of this description, flag 22 is a destination code that indicates a final package destination. Examples of final destinations are a merchant's warehouse, a liquidator, or a warranty, recall or repair center. This destination code may match a destination code embedded in barcode 25. In other embodiments, flag 22 could correlate to any sort of business “rule” of a merchant. As another example, visual flag 22 could indicate a quality of service, such as whether the package is to expedited or held for some reason. Or flag 22, could indicate the contents of the package, such as whether it is “high value” for special handling.

In general, flag 22 permits the package to be manually sorted at the returns center for subsequent routing. The examples set out above for its use are merchant-specific, in the sense that the flag is specific to a particular merchant and its returns processing rules. The flag, being human readable, can be easily correlated to rules displayed on a display in communication with processing system 119. These displays can be conveniently located at stations at the returns center and the displayed information used for sorting and other handling decisions.

The merchandise return rectangle 23 is specific to the carrier and pertains to the relationship between the carrier and the returns provider. In the example of this description, it states the USPS permit information of the returns provider.

The delivery address 24 is, as explained above, the address of a delivery location that is geographically nearest the customer. This determination of this address is dependent on the customer's postal code, as specified during the transaction leading to the return (such as the purchase transaction). As stated above, the delivery address could be a carrier center, such as a USPS bulk mail center, where it is held for pickup by the returns provider.

Barcode 25 is a dynamically generated machine-readable code that is based on unique information about the specific transaction involving the item(s) being returned. An example of barcode data is described below, but in general, the barcode data provides data for information servers 119 so that various “value added” returns processing tasks may be performed, such as manifesting of shipping charges, notifications to the customer and/or merchant, and final disposition of the returned item.

The barcode data permits the returns center to correlate the returned item back to the transaction with the customer. One type of correlation is an invoice number, as indicated by the example below.

Barcode 25 may comprise various alphanumeric or numeric only formats. Various other types of machine readable coding could be used as an alternative to bar-coding, such as other types of optical scan data or radio frequency identification (RFID) tagging. The coding may be printed or may be some other format, such as the electronic circuitry used in an RFID tag.

The “postage due” insignia 26, including the horizontal bars 26a, indicates to the customer and the carrier that shipping charges are to be paid by the recipient.

Barcode 25 is a “third party barcode” in the sense that need not be specified by the carrier, which in this case, is the USPS. Although not shown in FIG. 2, return label 20 may have one or more additional barcodes, for example a barcode containing data for the carrier's use, such as for carrier tracking or return confirmation.

FIG. 3 illustrates a data string that is an example of the contents of the barcode 25 of FIG. 2. The example of FIG. 3 has 24 positions, each with an alphanumeric character. The information in barcode 25 is “integrated” in the sense that it is contained in a single barcode or other machine readable string of data.

The barcode 25 contains multiple data points, and contains data that is “transaction specific”, in the sense that it identifies the transaction between the customer and the merchant or other party to whom the package is being delivered. The “transaction specific”data is dynamically generated in the sense that it is generated after the original order is made, and is specific to that transaction.

In general, the barcode data points are used to process the package for purposes other than moving it from one place to another. In contrast, “carrier specific” data elsewhere on the label 20 functions merely for shipping purposes.

Field 1 identifies the returns provider. Field 2 identifies the package destination.

Field 3 represents the shipping origin of the package (customer's postal code), which permits assessment of shipping charges from where the customer drops off the package (the return package origin) to the returns center (or a nearby BMC) where it is pulled from the carrier.

Field 4 identifies the merchant from whom the item was purchased. Or, as explained above, some party other than the merchant may be involved in the transaction leading to the return, such as a warranty or repair service.

Field 5, a selector field, may be used for various purposes, such as to identify the label type, or to identify a shipping category, such as Priority Mail or customer-paid.

Field 6 identifies the transaction involving the returned item in some manner. This is typically the purchase transaction, such as in the case of a customer returning recently purchased goods. This terminology is used herein for sake of consistency. This field is used to correlate the return label to the original order, such as by filling the field with the invoice number. This field could also be used for data such as a customer number, product number (such as an SKU), or other data.

As explained below, data on barcode 25 may be used to correlated the package (or the item inside) to merchant business rules. This involves identifying the merchant or the specific purchase transaction. Any date that permits such identification, whether explicitly or inferentially, may be sufficient for correlation of business rules.

If desired, one or more of the above-described fields could be omitted and another field used to link to the same information at the returns center. For example, Field 3 (the customer's postal code) could be omitted and Field 6 used at the returns center to dynamically link to stored data that provides the customer's postal code. In this event, barcode 25 would equivalently be considered to contain “data representing at least the origin of the package and identification of the transaction”.

It should be understood that the barcode data in the example of FIG. 3 is minimal and additional data could be easily included. Additional data points that may be included in the barcode 25 include data points falling into categories “transaction specific”, “merchant specific”, “customer specific”, “product specific”, “trading partner”, or “disposition” data. “Transaction specific” data identifies the transaction, such as by invoice number in the case of a purchase transaction. The “merchant specific” data identifies the merchant or some characteristic of the merchant. The “customer specific” identifies the customer or some characteristic of the customer. “Product specific” data identifies the package contents, such as by SKU number. “Trading partner” data describes a trading partner of the returns center, such as a liquidator or other service provider. “Disposition” data describes a disposition rule or final destination of the returned item.

Often, the merchant directly provides the return label (or data for generating the return label) to the customer. To this end, the returns provider provides the label specifications to the merchant, as well as a delivery address data file. This data file is used to correlate each customer's postal code to the returns provider location that is closest to the customer. The data file is made available to the merchant via data network access, such as by the internet.

In the example of FIGS. 2 and 3, the data on the returns label 20 is pre-printed. In other embodiments, the customer might fill in at least some of this data. For example, label 20 could have a predetermined format, and the customer would be directed to fill in certain information such as the customer's address, the package invoice number, or a shipping destination. However, in general, regardless whether label 20 is entirely pre-printed or all or partly filled by the customer, it is deemed to have a predetermined format, and prior to being shipped by the customer, to contain certain customer data as discussed in connection with FIGS. 2 and 3.

The various data elements described above in connection with FIGS. 2 and 3 can be used to implement the various returns services described herein, and some of these concepts may be implemented independently of others. For example, by using data representing the origin of the package (such as the customer's postal code), the returns center can perform reverse manifesting. By using data representing the original shipment (such as the identity of the merchant, the invoice, or the item), the returns center can dynamically route the package or notify the merchant or the customer about the status of the return.

Use of the Returns Label

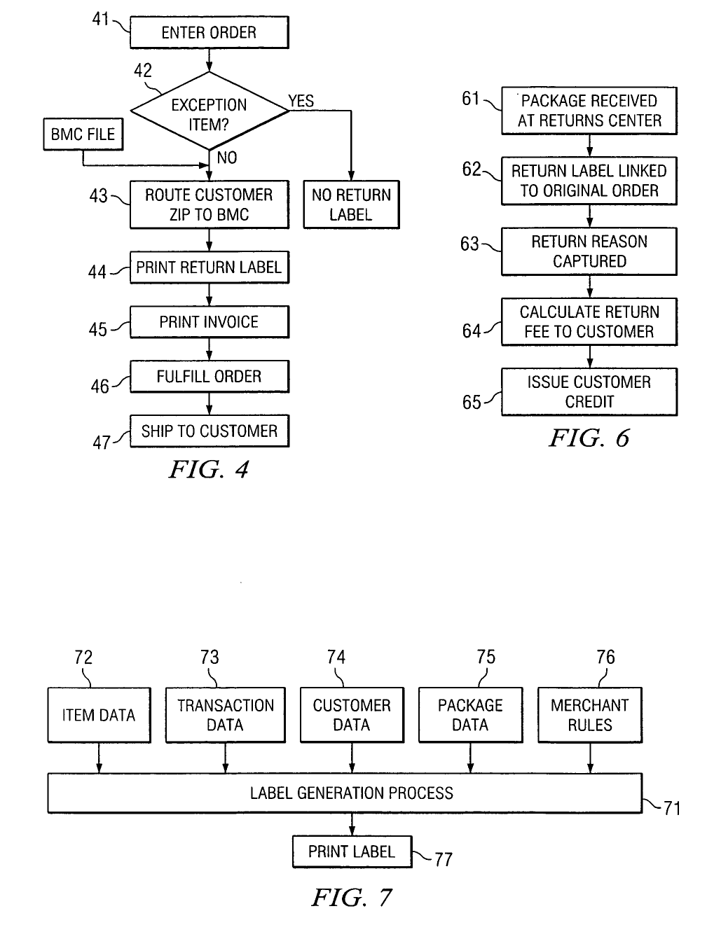

FIG. 4 illustrates a process of generating a return label, such as return label 20. In the example of FIG. 4, the return label 20 is to be provided to the customer in the original shipment. In Step 41, the merchant enters the order information to an automated order processing system. In Step 42, the merchant determines whether the order is an exception item. In Step 43, the merchant receives BMC (bulk mail center) data, which as explained above, is used to determine the BMC closest to the customer. In other embodiments, where the carrier is not the USPS, the address of some other carrier station close to the customer is used. In Steps 44 and 45, the return label and invoice are printed. In Steps 46 and 47, the order is fulfilled and shipped to the customer, with the return label being enclosed with the order.

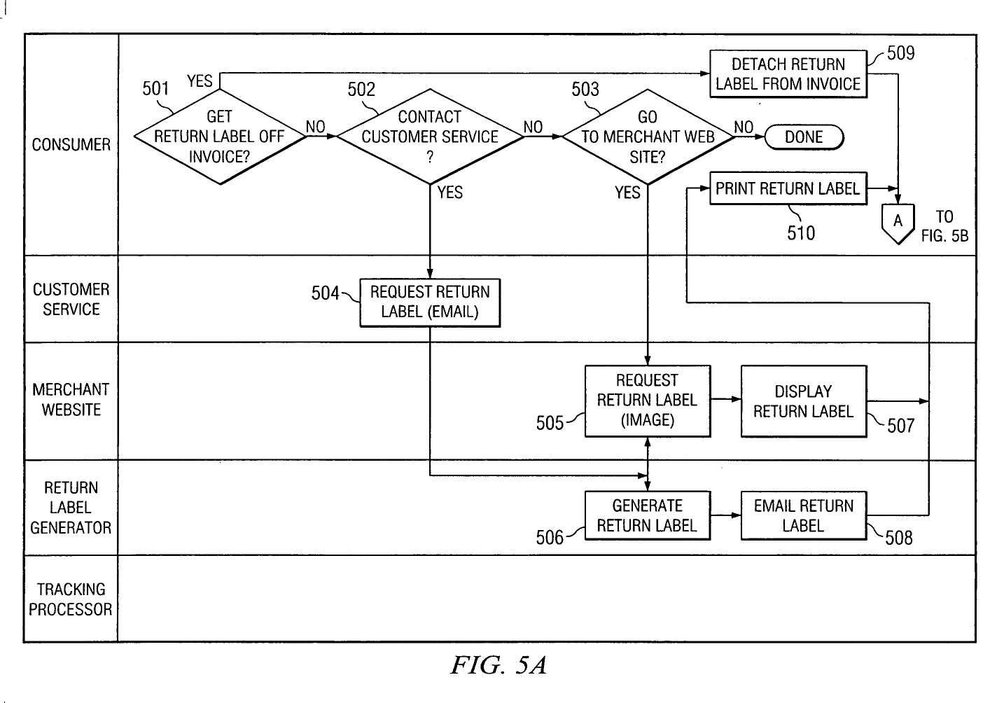

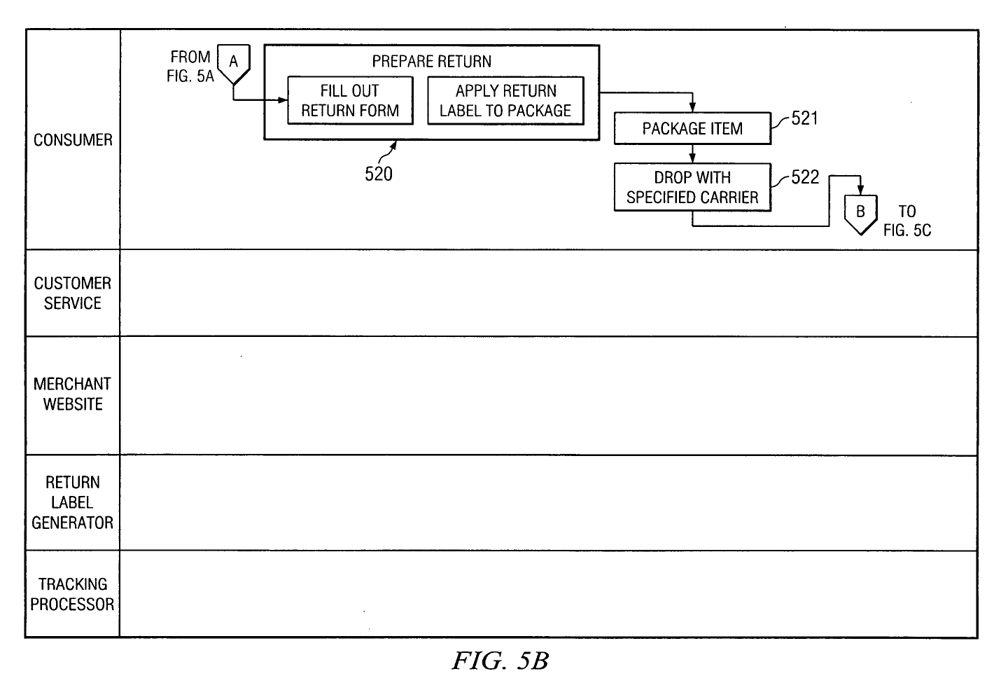

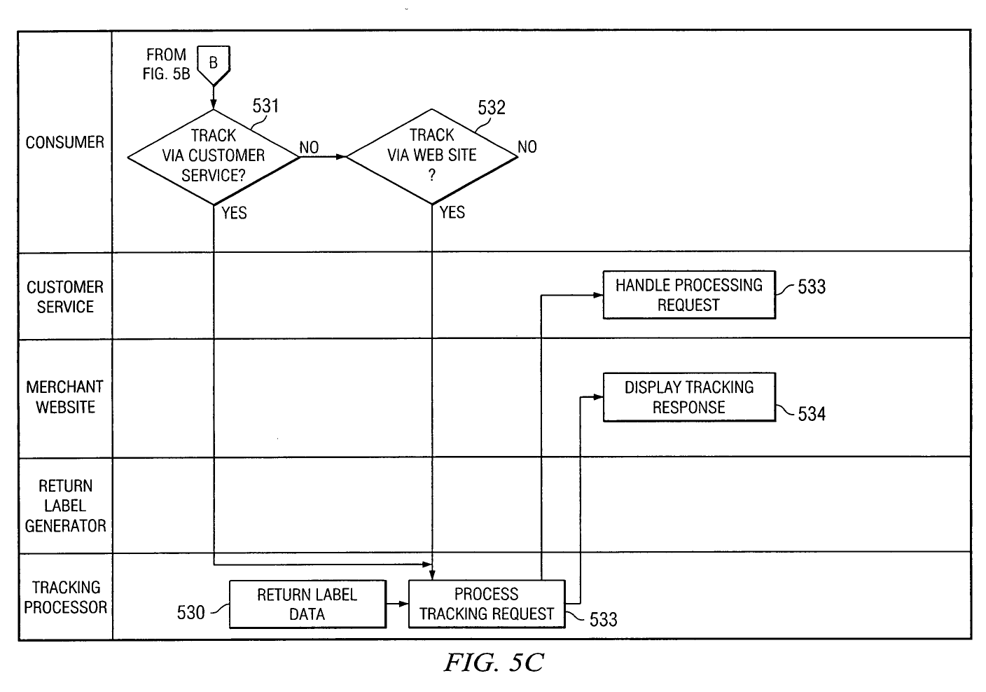

FIG. 5 illustrates the use of the return label 20 by the customer. Steps 501-510 illustrates various alternative ways for the customer to obtain the label 20. In Step 501, the customer receives the label 20 with the invoice in the original shipment, as described above in connection with FIG. 4. The customer may merely detach the label (Step 509).

In Step 502, the customer receives the label 20 by contacting customer service of the merchant, such as by phone call or email (Step 504). The label is then generated (Step 506) and emailed to the customer (Step 508).

In Steps 503 and 505, the customer receives the label by accessing a website and requesting an image. The label is generated and displayed (Steps 506 and 507) and the customer prints the label (Step 510).

In Step 520, the customer prepares the return by filling out a return form and applying the return label to the package. In Steps 521 and 522, the customer packages the return and drops it with the carrier specified by the merchant.

Steps 530-536 illustrate how data from the return label can be used to facilitate tracking requests. In Step 530, the package has been received at the returns center and scanned as described above in connection with FIG. 1. The data is stored and accessible by a tracking process, which may be part of processing system 119.

In Step 531, the customer makes a tracking request through customer service of the merchant. In Step 533, the request is processed, and the results communicated to the customer. In Step 532, the customer makes a tracking request via the merchant's website. In Steps 533 and 534, the request is processed and the results are displayed.

FIG. 6 illustrates an example of the use of return label 20 for issuing credit to the customer. FIG. 6 is an expansion of one aspect of the returns center processing in Step 114 of FIG. 1.

In Step 61, the package with the return label affixed is received at the returns center. It is assumed that return label 20 has at least some means to correlate the package to the original order, such as an invoice number. In Step 62, the label is scanned and linked to the original order. In Step 63, the reason for the return is captured, such as by reading the return form. The reason for the return may be used to determine whether the customer is to bear shipping costs for the return, and hence the amount of credit to the customer. The return reason may be communicated to the merchant, in addition to other return information, using processing system 119. In Step 64, the credit due the customer is calculated. Step 64 may involve accessing stored business rules of the merchant. In Step 65, data for implementing credit to the customer is delivered to the appropriate processing center.

Rules-Based Returns Processing

In all embodiments of the invention, an important feature is the use of merchant business rules. These rules can specify any aspect of returns handling, including without limitation, sorting, notification, examination, disposition, and crediting. The merchant can update or condition the rules as desired. The rules permit the return process to be dynamic, in the sense that they can be changed independently of any tags, codes, or other indicia printed or attached to the package or item being returned.

Rules can be consulted prior to printing of the return label and used to print a label that ensures that the package will be processed according to the rules. Rules may also be consulted, after a return label has been printed, for example, upon arrival at a returns center, which means that they can be changed after an item has been sold and while it is in transit.

FIG. 7 illustrates rules-based label generation in accordance with the invention. For purposes of FIG. 7, it is assumed that rules are consulted prior to printing the return label. These rules determine the coding that is to be imprinted on the label. The rules, as reflected by appropriate coding, may determine a variety of shipping parameters, such as the destination of the item, the choice of carrier, the type of postal service (class or rating). In essence, an optimized transportation path for the package is determined prior to printing the label, so that the label can be appropriately printed to achieve that path.

The label generating process 71 may be implemented regardless of the type of delivery of the label. In other words, for labels that are to be physically delivered to a customer, process 71 is performed so that the label may be printed and included in the package, mailed to the customer, or otherwise delivered. For labels that are generated via a website, process 71 is performed so that the label may be downloaded to the customer and printed. Other delivery mechanisms include faxing or emailing the return label to the customer.

The return label generation process 71 receives as input, for generating a particular return label, item data 72, transaction data 73, customer data 74, and package data 75. Item data 72 pertains to the item being returned, for example, an identification of the type of item or its value. A specific example of item data is an SKU number. Transaction data includes, for example, an invoice number or a transaction date. Customer data might be the origin of the return shipment (typically the customer's ZIP code or other address data), and customer preferences such as urgency, pick up requests, or carrier preference. Customer data may also indicate data such as whether or not the return shipping costs are to be paid by the customer, the merchant, or a third party. The package data includes, for example, the size and weight of the package in which the item is expected to be returned. If more than one item is to be returned, the package data may calculate these parameters from the item data.

Process 71 accesses a set of merchant rules 76, which specify how packages meeting specified criteria are to be shipped. As stated above, the rules may specify such particulars as the type of carrier, the destination, and shipping classes or ratings. Once these particulars are determined, process 71 then generates the label data, which appropriated coding. This coding ensures that the package complies with the requirements of the selected carrier and rating and that it will be routed to the selected destination. As explained above, a feature of return label 20 is that it contains machine readable code that is integrated into the same label as the carrier-compliant information and format used by the carrier. Examples of carrier compliant formats are those used by today's commercial shipping services, such as UPS, Federal Express, or the U.S. Postal Service.

A print process 77 then prints the label. As stated above, the printing may be by the customer to whom label data has been downloaded. Or the label may be printed during order fulfillment process and included in the package when the item is shipped to the customer.

It should be understood that process 71 is a computer-implemented process, performed by computing equipment with appropriate hardware and software. The various data sets 72-75 and rules 76 are stored in memory accessible by process 71. The memory may be immediate to process 71 or may be communicated over a network. Data in data sets 72-75 may be supplied in real time, such as by a customer requesting a return, or may have been previously acquired.

Business rules 76 may be stored in an open format, such as XML, so that they may easily communicated. They may also be stored in a format that is easily transportable to information processing systems used by merchants, who may then integrate rules-based return label printing and processing into those systems. Similarly, label rendering process 77 may be a portable process, integratable into merchant systems. For example, rules 76 and/or process 77 could be integrated into a comprehensive inventory/sales merchant system.

In the case where rules are consulted at a returns center, barcode 25 and any other indicia on the package may be used to correlate to the merchant's current set of rules. For example, if shoes are returned when they are out of season, a current rule can specify that they are to be liquidated rather than returned to stock.

What is claimed is:

1. A computer-implemented method of providing merchandise return labels for enabling a customer to ship a package containing one or more items previously acquired from a merchant during a unique transaction, comprising the steps of:
accessing item data representing at least one detail about the item;
accessing transaction data representing at least one detail about the transaction associated with the item;
accessing customer data representing at least one detail about a customer associated with the transaction;
accessing package data representing at least one detail about the package in which the item is expected to be shipped;
correlating the item data, transaction data, customer data, and package data, with a set of stored business rules; wherein the business rules represent guidelines for determining at least one shipping parameter selected from the group of: choice of carrier, shipping destination, shipping rate, or package disposition;
generating a machine readable code, wherein the data represents the results of the correlating step and represents at least a shipping origin of the package and identification of the transaction; and
formatting the return label, such that the return label contains the machine readable code and complies with shipping label specifications of a carrier.

2. The method of claim 1, wherein the item data identifies an item type.

3. The method of claim 1, wherein the item data identifies an item value.

4. The method of claim 1, wherein the transaction data is a transaction identifier.

5. The method of claim 1, wherein the transaction data is a transaction date.

6. The method of claim 1, wherein the customer data represents a shipping origin.

7. The method of claim 1, wherein the customer data represents customer preferences.

8. The method of claim 1, wherein the customer data identifies a payee of shipping costs.

9. The method of claim 1, wherein the package data represents package weight.

10. The method of claim 1, wherein the package data represents package size.

11. The method of claim 1, further comprising the step of accessing shipping rate data.

12. The method of claim 1, further comprising the step of accessing carrier center location data.

13. The method of claim 12, wherein the carrier center location data represents bulk mail center data.

14. A computer product for providing merchandise return labels for enabling a customer to ship a package containing one or more items previously acquired from a merchant during a unique transaction, comprising programming operable to:
access item data representing at least one detail about the item;
access transaction data representing at least one detail about the transaction associated with the item;
access customer data representing at least one detail about a customer associated with the transaction;
access package data representing at least one detail about the package in which the item is expected to be shipped;
correlate the item data, transaction data, customer data, and package data, with a set of stored business rules; wherein the business rules represent guidelines for determining at least one shipping parameter selected from the group of: choice of carrier, shipping destination, shipping rate, or package disposition;
generate a machine readable code, wherein the data represents the results of the correlating step and represents at least a shipping origin of the package and identification of the transaction; and
format the return label, such that the return label contains the machine readable code and complies with shipping label specifications of a carrier.

15. The product of claim 14, wherein the programming is operable to access at least one of the group of item data, customer data, transaction data, or product data, via a remote data communications link.

16. The product of claim 14, wherein the programming is further operable to access shipping rate data.

17. The product of claim 14, further comprising the step of accessing carrier center location data.

18. The product of claim 14, wherein the carrier center location data represents bulk mail center data.

19. The product of claim 14, wherein the item data identifies an item type.

20. The product of claim 14, wherein the item data identifies an item value.

21. The product of claim 14, wherein the transaction data is a transaction identifier.

22. The product of claim 14, wherein the transaction data is a transaction date.

23. The product of claim 14 wherein the customer data represents a shipping origin.

24. The product of claim 14, wherein the customer data represents customer preferences.

25. The product of claim 14, wherein the customer data identifies a payee of shipping costs.

26. The product of claim 14, wherein the package data represents package weight.

27. The product of claim 14, wherein the package data represents package size.

28. A computer product for providing merchandise return labels for enabling a customer to ship a package containing one or more items previously acquired from a merchant during a unique transaction, comprising programming operable to:
access item data representing at least one detail about the item;
access transaction data representing at least one detail about the transaction associated with the item;
correlate the item data and transaction data with a set of stored business rules; wherein the business rules represent guidelines for determining at least one shipping parameter selected from the group of: shipping destination or shipping rate;
generate a machine readable code, wherein the data represents the results of the correlating step and represents at least a shipping origin of the package and identification of the transaction; and
format the return label, such that the return label contains the machine readable code and complies with shipping label specifications of a carrier.

29. The product of claim 28, wherein the programming is further operable to access customer data representing at least one detail about a customer associated with the transaction, to further correlate customer data with the business rules.

30. The product of claim 28, wherein the programming is further operable to access package data representing at least one detail about the package in which the item is expected to be shipped, and to further correlate package data with the business rules.

31. The product of claim 28, wherein the shipping parameters further may comprise choice of carrier.

32. The product of claim 28, wherein the shipping parameters further may comprise package disposition.
